(19) United States
(12) Patent Application Publication
(10) Pub. No.: US 2026/0077628 A1
(43) Pub. Date: Mar. 19, 2026

(54) VIBRATION DAMPER FOR A MOTOR VEHICLE

(71) Applicants: thyssenkrupp Bilstein GmbH, Ennepetal (DE); thyssenkrupp AG, Essen (DE)

(72) Inventor: Lars SCHWEDLER, Arnsberg (DE)

(73) Assignees: thyssenkrupp Bilstein GmbH, Ennepetal (DE); thyssenkrupp AG, Essen (DE)

(21) Appl. No.: 19/327,996

(22) Filed: Sep. 12, 2025

(30) Foreign Application Priority Data
Sep. 13, 2024 (DE) 10 2024 126 391.1

(51) Int. Cl. B60G 17/08; B60G 13/08

(52) U.S. Cl. CPC B60G 17/08; B60G 13/08; B60G 2202/24; B60G 2204/62; B60G 2206/41; B60G 2500/104; B60G 2600/21; B60G 2800/162; B60G 2800/916

(57) ABSTRACT

A vibration damper for a vehicle comprises a damper tube filled with hydraulic fluid, a working piston which is connected to a piston rod and arranged within the damper tube so as to be movable back and forth, wherein the interior of the damper tube is divided by the working piston into a first working chamber and a second working chamber, a closure assembly which fluid-tightly closes off the damper tube at the piston rod side, a rebound stop arrangement having a rebound stop piston, which is mounted on the piston rod, and a rebound stop sleeve for receiving the rebound stop piston in the rebound stage, wherein the rebound stop piston separates off a rebound stage working chamber within the rebound stop sleeve, and wherein the rebound stop piston has a bypass channel for fluidically connecting the piston-rod-side working chamber to the rebound stage working chamber, wherein a valve device is arranged in the rebound stop piston hydraulically in parallel to the bypass channel.

### CROSS REFERENCE TO RELATED APPLICATION

This application is a U.S. Non-Provisional that claims priority to German Patent Application No. DE 10 2024 126 391.1, filed Sep. 13, 2024, the entire content of which is incorporated herein by reference.

### FIELD

The present disclosure relates to a vibration damper for a motor vehicle having a rebound stop arrangement.

### BACKGROUND

DE102022129427A1 discloses a hydraulic vibration damper having a hydraulic rebound stop. A hydraulic rebound stop usually serves to provide additional damping in the rebound stage of the vibration damper. For this purpose, in known vibration dampers, a rebound stop piston plunges into a rebound stop chamber, and thus generates additional damping when the piston rod moves in the rebound direction. The components that interact in the case of rebound damping usually have to adhere to very precise manufacturing tolerances, in order to for example compensate for transverse forces on the piston rod. Said components are therefore usually very expensive to manufacture. Furthermore, there is the risk of the rebound stop arrangement being damaged, particularly in the case of high pressures.

Thus a need exists to provide a vibration damper having a rebound stop arrangement which is inexpensive to produce and provides reliable damping even in the case of high pressures.

### BRIEF DESCRIPTION OF THE FIGURES

So that those skilled in the art to which the subject disclosure appertains will readily understand how to make and use the devices and methods of the subject disclosure without undue experimentation, preferred embodiments thereof will be described in detail herein below with reference to certain figures, wherein:

FIG. 1 shows a schematic illustration of a vibration damper according to the prior art in a longitudinal sectional view.

FIG. 2 shows a schematic illustration of a partial cutout of a vibration damper in a longitudinal sectional view according to one exemplary embodiment.

FIG. 3 shows a schematic illustration of a partial cutout of a vibration damper in a longitudinal sectional view according to a further exemplary embodiment.

### DETAILED DESCRIPTION

Although certain example methods and apparatus have been described herein, the scope of coverage of this patent is not limited thereto. On the contrary, this patent covers all methods, apparatus, and articles of manufacture fairly falling within the scope of the appended claims either literally or under the doctrine of equivalents. Moreover, those having ordinary skill in the art will understand that reciting “a” element or “an” element in the appended claims does not restrict those claims to articles, apparatuses, systems, methods, or the like having only one of that element, even where other elements in the same claim or different claims are preceded by “at least one” or similar language. Similarly, it should be understood that the steps of any method claims need not necessarily be performed in the order in which they are recited, unless so required by the context of the claims. In addition, all references to one skilled in the art shall be understood to refer to one having ordinary skill in the art.

According to a first aspect, a vibration damper for a vehicle comprises a damper tube filled with hydraulic fluid, and a working piston which is connected to a piston rod and arranged within the damper tube so as to be movable back and forth, wherein the interior of the damper tube is divided by the working piston into a first, piston-rod-side working chamber and a second working chamber remote from the piston rod. The vibration damper also comprises a closure assembly which fluid-tightly closes off the damper tube at the piston rod side, and a rebound stop arrangement having a rebound stop piston, which is mounted on the piston rod, and a rebound stop sleeve for receiving the rebound stop piston in the rebound stage. The rebound stop piston separates off a rebound stage working chamber within the rebound stop sleeve, and the rebound stop piston has a bypass channel for fluidically connecting the piston-rod-side working chamber to the rebound stage working chamber. A valve device is arranged in the rebound stop piston hydraulically in parallel to the bypass channel.

The vibration damper is for example a single-tube or a multi-tube vibration damper. For example, a multi-tube vibration damper for a vehicle comprises an outer tube and an inner tube arranged coaxially with respect to said outer tube, wherein, between the outer tube and the inner tube, there is formed an equalizing chamber for receiving hydraulic fluid, and a working piston which is connected to a piston rod and arranged within the inner tube so as to be movable back and forth, wherein the interior of the inner tube is divided by the working piston into a first, piston-rod-side working chamber and a second working chamber remote from the piston rod. The equalizing chamber is preferably at least partially filled with a gas, in particular at the upper end. The outer tube preferably at least partially forms the housing of the vibration damper. The inner surface of the inner tube is preferably formed as a guide for the working piston. The working piston preferably has a valve device by means of which the first and the second working chamber are connected to one another. In the case of a single-tube vibration damper, it is preferably the case that no outer tube is provided. The inner tube is preferably referred to as a damper tube, and receives the piston rod and the working piston as described above with regard to the inner tube.

In the case of a multi-tube vibration damper, the vibration damper has, in particular, a closure assembly which is designed and arranged to fluidically seal off the interior of the outer tube at the piston rod side. The piston-rod-side end of the inner tube is preferably fastened to the closure assembly. Opposite the closure assembly, at the end remote from the piston rod, the equalizing chamber and the second working chamber are preferably fluidically sealed off by means of a base piece. The equalizing chamber is preferably fluidically connected to the first or second working chamber via openings in the inner tube. For example, the equalizing chamber is sealed off in relation to the inner tube by means of a base element.

In the case of a single-tube vibration damper, the vibration damper has, in particular, a closure assembly which is designed and arranged to fluidically seal off the interior of the damper tube at the piston rod side. The piston-rod-side end of the damper tube is preferably fastened to the closure assembly. Opposite the closure assembly, at the end remote from the piston rod, the interior of the damper tube is preferably fluidically sealed off by means of an axially movable sealing element. The sealing element preferably separates a gas space, which is adjacent thereto in the axial direction, from the working chamber which is filled with hydraulic fluid. The closure assembly is preferably arranged coaxially with respect to, and circumferentially surrounds, the piston rod. For example, the rebound stop sleeve is fastened to the closure assembly. In particular, the rebound stop sleeve is radially clamped on the closure assembly. Optionally, the rebound stop sleeve has a circumferential groove or a diameter constriction at the upper end region, into which a radially projecting region of the closure assembly engages and forms a clamping connection.

In the description that follows, the term “vibration damper” should be understood to mean both a multi-tube vibration damper and a single-tube vibration damper, wherein the damper tube is the inner tube of a multi-tube vibration damper.

The rebound stop arrangement is preferably arranged within the damper tube, in particular in the piston-rod-side end region of the damper tube, and preferably comprises the rebound stop piston, which is mounted on the piston rod, and the rebound stop sleeve, which lies against the inner wall of the damper tube. Preferably, the outer circumferential surface of the rebound stop piston lies fluid-tightly at least partially or completely against the inner wall of the rebound stop sleeve. The rebound stop arrangement also comprises the rebound stage working chamber which is separated off by the rebound stop piston within the rebound stop sleeve, preferably within the piston-rod-side working chamber. The rebound stop piston is arranged on the piston rod preferably behind the working piston in the rebound direction, in particular between the working piston and the closure assembly.

The rebound stop piston is preferably of annular design. Preferably, the rebound stop piston, in particular the end face facing towards the closure assembly, forms a stop surface for abutment against the closure assembly when the piston rod moves in the rebound direction. The rebound stop piston serves in particular to limit the movement of the piston rod in the rebound direction. The rebound stop sleeve is mounted coaxially with respect to the inner tube and preferably lies fluid-tightly against the inner wall of the inner tube. Preferably, formed between the rebound stop piston and the inner wall of the rebound stop sleeve is the bypass channel, in particular a flow gap, through which the hydraulic fluid can flow in the case of a piston rod movement.

The rebound stop piston is in particular mounted within the damper tube so as to be axially movable with the piston rod. Preferably, the outer circumferential surface is at least partially or completely spaced apart from the inner wall of the damper tube, with the result that a flow passage, in particular an annular chamber, is formed between the rebound stop piston and the inner tube. In particular, when the rebound stop piston moves outside the rebound stop sleeve in the bump direction or rebound direction, the rebound stop piston presents a low to negligible flow resistance. The rebound stop sleeve preferably serves as an axial guide for the rebound stop piston.

The rebound piston sleeve has by way of example at least one or a plurality of apertures, which preferably extend from the lower end, facing towards the base piece, of the rebound stop sleeve in the axial direction. Preferably, the apertures are designed in such a way that their flow cross-sectional area reduces in the axial direction upwards, in the direction of the closure assembly. Preferably, the apertures extend over approximately one third up to at most half of the axial length of the rebound stop sleeve. The rebound stop sleeve preferably has a plurality of apertures which are in particular arranged spaced apart circumferentially uniformly with respect to one another. Preferably, the apertures are all of identical design. The apertures in particular form a bypass path for hydraulic fluid to the rebound stop piston. The apertures having a cross-sectional area which reduces in the axial direction ensure progressive damping when the rebound stop piston moves in the rebound direction.

A movement in the rebound direction should be understood to mean a movement in the direction of the closure assembly into the piston-rod-side region of the shock damper, and a movement in the bump direction should be understood to mean a movement in the direction of the base piece into that region of the shock damper which is remote from the piston rod.

According to a first embodiment, the rebound stop piston has a throttle element for setting the flow cross section of the bypass channel, said throttle element being mounted so as to be movable in the axial direction. The throttle element is in particular a piston ring, which is preferably of annular, in particular C-ring-shaped, design. The throttle element is preferably mounted so as to be movable in the axial direction relative to the other elements of the rebound stop piston.

According to a further embodiment, the rebound stop piston, in particular the valve device, comprises a valve body having at least one or a plurality of axial passage bores which are at least partially or completely covered by valve discs at the piston rod side. The valve discs are preferably preloaded in such a way that they allow a flow out of the rebound stage working chamber into the piston-rod-side working chamber through the passage bores from a determined pressure in the rebound stage working chamber. The valve discs are preferably mounted at the working-piston-side end of the valve body. The passage bores together with the valve discs thus prevent a pressure increase beyond a determined value in the rebound stage working chamber. The bypass channel is provided in addition to the passage bores and offers an additional flow channel when the rebound stop piston moves in the bump or rebound direction. The bypass channel is in particular formed between the valve body and the throttle element.

The throttle element, in particular the piston ring, is preferably arranged circumferentially around the valve body and is in particular mounted so as to be movable axially relative to the valve body. The valve body preferably has, at its piston-rod-side end, a radially outwardly facing shoulder which forms an axial abutment surface for the throttle element. The throttle element is preferably mounted around the outer circumference of the valve body and is in particular designed and arranged in such a way that it fluid-tightly closes with the inner wall of the rebound stop sleeve. The throttle element has, for example, a passage opening through which hydraulic fluid can flow. The rebound stop piston preferably has a disc which is mounted at that end of the rebound stop piston, in particular of the valve body, which is remote from the piston rod. The disc preferably protrudes radially beyond the valve body and forms an axial abutment surface for the throttle element.

In particular, the bypass channel is at least partially formed by apertures in the valve body. The apertures are preferably formed in the radially outwardly facing circumferential surface of the valve body. The valve body has, for example, a plurality of apertures which are arranged spaced apart circumferentially in particular uniformly with respect to one another. The apertures preferably extend in the axial direction from that end of the valve body which is remote from the piston rod up to the shoulder of the valve body. Optionally, the apertures are of half-shell-like design, in particular with a semicircular cross section. It is also conceivable for the apertures to have a round, part-circle or angular cross section. In particular, all the apertures are of identical design.

In particular, the disc has a plurality of cutouts through which the hydraulic fluid can flow. The cutouts are preferably arranged aligned with the apertures, wherein preferably at least some of the cutouts are preferably arranged aligned with the passage bores of the valve body that interact with valve discs. The bypass channel is preferably formed by the cutouts in the disc, the apertures in the valve body and the throttle element.

According to a further embodiment, the throttle element is designed and arranged in such a way that it, in a first position, releases a first flow cross section of the bypass channel and, in a second position, releases a second flow cross section of the bypass channel. According to a further embodiment, the first flow cross section is smaller than the second flow cross section. According to a further embodiment, the throttle element is arranged in such a way that it is moved into the first position when the rebound stop piston moves in the rebound direction and into the second position when the rebound stop piston moves in the bump direction. This makes it possible for the rebound stop piston to experience stronger damping in the case of a movement in the rebound direction than in the case of a movement in the bump direction. The rebound stop piston thus performs the function of a rebound stop with additional damping of the piston rod in the rebound direction.

The throttle element is preferably arranged and designed in such a way that it, when the rebound stop piston moves in the rebound direction, lies against the shoulder of the valve body and at least partially or completely closes the bypass channel. Preferably, the bypass channel has a first flow cross section which corresponds by way of example to the cross section of the passage opening in the throttle element. The throttle element is preferably arranged and designed in such a way that it, when the rebound stop piston moves in the bump direction, lies against a shoulder, in particular against the disc, and releases the bypass channel, in particular the second flow channel.

According to a further embodiment, the throttle element is of annular, in particular circular-ring-shaped, preferably C-ring-shaped, design. The throttle element in the form of a piston ring has, for example, a passage opening which is in the form of a slot and forms a complete circumferential interruption of the annular piston ring. Optionally, the throttle element has a plurality of passage openings, circumferentially opposite passage opening is preferably being of identical design. In particular, the passage opening is in the form of an aperture in the inner wall and/or the piston-rod-side end side of the throttle element.

According to a further embodiment, the rebound stop piston lies fluid-tightly against the inner wall of the rebound stop sleeve, wherein the rebound stop sleeve forms a guide for the rebound stop piston.

According to a further embodiment, the rebound stop piston is fastened to, in particular clamped or pressed on, the piston rod by means of a fastening means. The valve body, the valve discs and the disc are preferably fixed to the piston rod in particular by means of the fastening means.

According to a further embodiment, the fastening means has at least one catch ring. A catch ring is preferably understood to mean an annular element fastened to the piston rod. The catch ring preferably comprises an annular region and a fastening region, which is directly adjacent to said annular region and has a plurality of catch arms. The catch arms preferably extend in the axial direction and are in particular bendable in the radial direction, with the result that they can be latched into an aperture in the piston rod and preferably a determined preload can be applied to the catch ring by means of the catch arms.

According to a further embodiment, the fastening means has a first catch ring and a second catch ring, wherein the valve device of the rebound stop piston is arranged between the first and the second catch ring. In particular, the fastening means has a first catch ring which forms the closure-assembly-side end of the rebound stop piston. The fastening means in particular also has a second catch ring which forms the working-piston-side end of the rebound stop piston. The first and the second catch ring are preferably of annular design and arranged circumferentially around the piston rod. In particular, the catch rings are clamped with the piston rod. Preferably, the piston rod has a first and a second recess, which are each at least partially or completely formed in the circumferential direction in the piston rod. By way of example, the first catch ring is at least partially arranged in the first recess and forms therewith a press-fit connection or clamping connection. By way of example, the second catch ring is at least partially arranged in the second recess and forms therewith a press-fit connection or clamping connection.

According to a further embodiment, the rebound stop piston has a spacer disc which lies against the valve disc and a catch ring. The spacer disc preferably spaces the valve discs apart from the second catch ring and thus preferably enables an opening of the valve discs. The spacer disc preferably has a smaller diameter than the valve discs and lies directly against them, in particular against the lowermost valve disc.

According to a further embodiment, the valve device is in the form of a check valve. As a result, the valve device becomes active exclusively in the rebound stage and prevents an excessive pressure within the rebound stop sleeve.

According to a further embodiment, the valve body has the radial shoulder against which the throttle element lies in the first position. Preferably, the throttle element lies exclusively against the radial shoulder in the first position.

According to a further embodiment, the rebound stop piston has a disc which lies against the valve body, wherein the throttle element lies against the disc in the second position. Preferably, the throttle element lies exclusively against the radial shoulder in the first position.

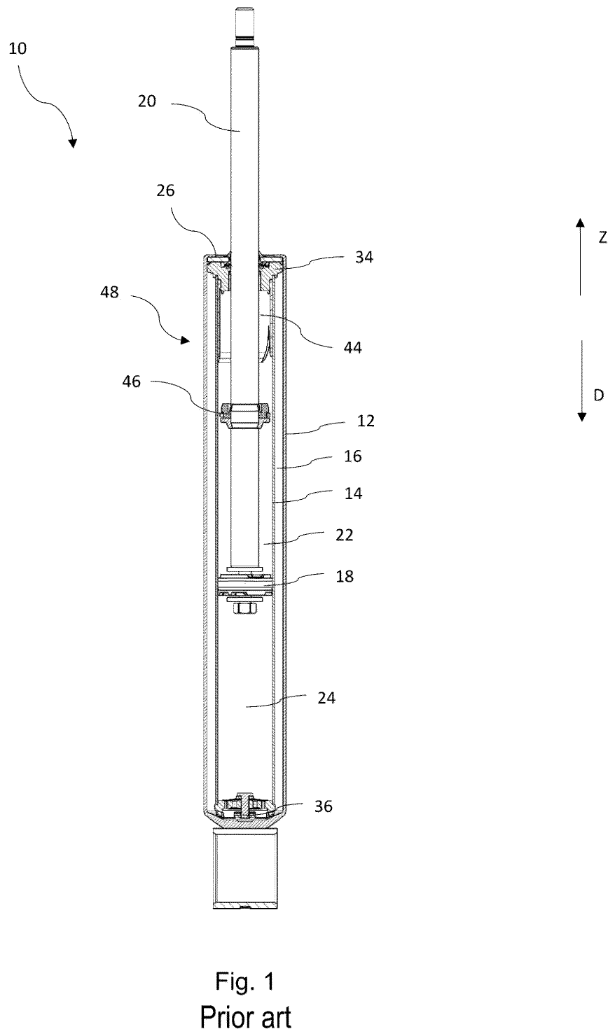

FIG. 1 shows a vibration damper 10 according to the prior art, the vibration damper 10 being by way of example a multi-tube vibration damper, by way of example a two-tube vibration damper. The vibration damper 10 has an outer tube 12 which forms an outer surface, in particular a housing, of the vibration damper 10. Arranged within the outer tube 12, coaxially with respect thereto, is a damper tube 14 which is also referred to as inner tube 14. Formed between the outer tube 12 and the inner tube 14 is an equalizing chamber 16 which is preferably at least partially or completely filled with a hydraulic fluid. For example, the equalizing chamber 16 is partially filled with a gas.

A working piston 18, which is connected to a piston rod 20, is arranged within the inner tube 14 in such a way that it is movable within the inner tube 14, the inner tube 14 preferably being formed as a guide for the working piston 18. The working piston 18 preferably has a valve device. For example, the valve device comprises a rebound stage valve, for damping the piston movement in the rebound stage, and a bump stage valve, for damping the piston movement in the bump stage. Preferably, the valves are each formed by a passage opening through the piston and by a valve disc assembly. The working piston 18 divides the interior of the inner tube 14 into a first working chamber 22, which is arranged at the piston rod side, and a second working chamber 24, which is remote from the piston rod. The piston rod 20 is preferably connectable, by way of its end which projects out of the damper tube 14, to the vehicle body.

The interior of the outer tube 12 is fluidically sealed off at the piston rod side by means of a closure assembly 34. Opposite the closure assembly 34, at the end remote from the piston rod, the equalizing chamber 16 is fluidically sealed off by means of a base piece 36. The interior of the damper tube 14, in particular the second working chamber 24, is preferably also fluidically sealed off by means of the base piece 36. It is also conceivable for a further base element to be provided separately from the base piece, which seals off the outer tube. Preferably, the vibration damper 10 has a base valve. The piston-rod-side end of the inner tube 14 is preferably fastened to the closure assembly 34.

The vibration damper 10 comprises by way of example a rebound stop arrangement 48 having a rebound stop piston 46 which is positionally fixedly mounted on the piston rod 20. The rebound stop piston 46 is by way of example of annular design and arranged between the working piston 18 and the closure assembly 34 within the first working chamber 22. Preferably, the rebound stop piston 46, in particular the end face facing towards the closure assembly 34, forms a stop surface for abutment against the closure assembly 34 when the piston rod 20 moves in the rebound direction Z. The rebound stop piston 46 serves to limit the movement of the piston rod 20 in the rebound direction Z. The rebound stop arrangement 48 also comprises a rebound stop sleeve 44 which is mounted coaxially with respect to the inner tube 14 and preferably lies fluid-tightly against the inner wall of the inner tube 14. Preferably, formed between the rebound stop piston 46 and the inner wall of the rebound stop sleeve 44 is a flow gap, through which the hydraulic fluid can flow in the case of a piston rod movement.

The rebound stop piston 46 known from the prior art has a piston ring 64. The piston ring 64 is for example of C-ring-shaped design and has a passage opening through which hydraulic fluid can flow. The passage opening formed in the piston ring 64 constitutes a characteristic-defining element, with the result that in the rebound stage, when the rebound stage piston 46 plunges into the rebound stage sleeve 48, a damping action is produced which is dependent on the size of the passage opening. It is disadvantageous that, particularly in the case of high pressures, the passage opening is not sufficient to achieve pressure equalization, for which reason damage to the rebound stop arrangement can occur. When dimensioning the passage opening, the flow cross section is adapted to the maximum flow rate, such that damage to the vibration damper is prevented. However, such dimensioning of the passage opening results in low to negligible damping in the case of lower flow rates.

The movement direction of the piston rod 20 in the bump stage D and in the rebound stage Z is illustrated by means of the arrows Z and D in FIG. 1.

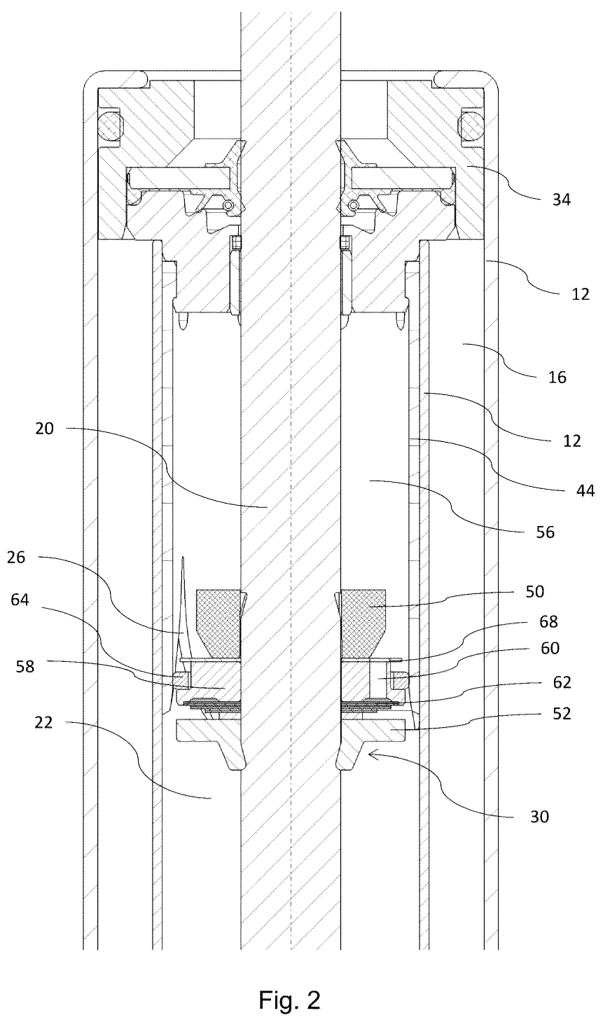

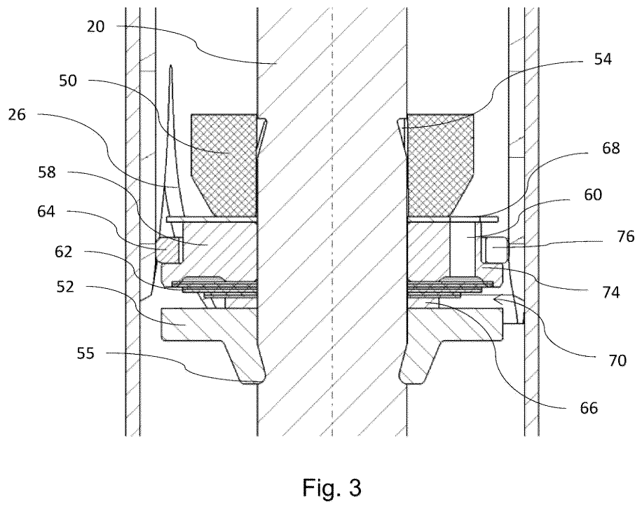

FIGS. 2 and 3 each show a cutout of a vibration damper according to a respective exemplary embodiment of the invention. The vibration damper in FIGS. 2 and 3 corresponds partially to the vibration damper in FIG. 1, identical elements being provided with identical reference signs. In particular, the vibration damper 10 in FIGS. 2 and 3 differs from the one in FIG. 1 by the design of the rebound stop piston 46. The rebound stop piston 46 is mounted within the damper tube 14 so as to be axially movable. Preferably, the outer circumferential surface is at least partially or completely spaced apart from the inner wall of the damper tube 14, with the result that a flow passage, in particular an annular chamber, is formed between the rebound stop piston 46 and the inner tube 14. In particular, when the rebound stop piston 46 moves outside the rebound stop sleeve 44 in the bump direction or rebound direction Z, the rebound stop piston 46 presents a low to negligible flow resistance. The rebound stop sleeve 44 preferably serves as a guide for the rebound stop piston 46, the outer circumference of the rebound stop piston 46 preferably lying fluid-tightly against the inner wall of the rebound stop sleeve 44.

The rebound stop piston 46 is by way of example positionally fixedly mounted on the piston rod 20. The rebound stop arrangement 48 in particular also comprises a rebound stop sleeve 44 which is mounted at the upper end, facing towards the closure assembly 34, of the inner tube 14 and in particular lies fluid-tightly against the inner side of the inner tube 14. The rebound stop sleeve 44 has by way of example at least one or a plurality of apertures 26, which preferably extend from the lower end, facing towards the base piece 36, of the rebound stop sleeve 44 in the axial direction. Preferably, the apertures 26 are designed in such a way that their flow cross-sectional area reduces in the axial direction upwards, in the direction of the closure assembly 34. Preferably, the apertures extend over approximately one third up to at most half of the axial length of the rebound stop sleeve 44. The rebound stop sleeve 44 preferably has a plurality of apertures 26 which are in particular arranged spaced apart circumferentially uniformly with respect to one another. Preferably, the apertures 26 are all of identical design. The apertures 26 in particular form a bypass path for hydraulic fluid to the rebound stop piston 46. The apertures 26 having a cross-sectional area which reduces in the axial direction ensure progressive damping when the rebound stop piston 46 moves in the rebound direction Z.

The rebound stop piston 46 in particular separates off a rebound stage working chamber 56 within the rebound stop sleeve 44, preferably within the first, piston-rod-side working chamber 22. The rebound stop piston 46 is in particular arranged axially between the working piston 18 and the closure assembly 34.

The rebound stop piston 46 preferably comprises a valve device 70, wherein the valve device 70 has a valve body 58 having at least one or a plurality of axial passage bores 60 which are covered by valve discs 62. The valve discs 62 are mounted at the working-piston-side end of the valve body 58 and preferably preloaded in such a way that they allow a flow out of the rebound stage working chamber 56 through the passage bores 60 into the first working chamber 22 from a determined pressure in the rebound stage working chamber 56. The passage bores 60 together with the valve discs 62 thus prevent a pressure increase beyond a determined value in the rebound stage working chamber 56.

The rebound stop piston 46 comprises by way of example a piston ring 64, which is arranged circumferentially around the valve body 58 and is in particular axially movable. The piston ring 64 is for example of circular-ring-like or cylindrical design. The valve body 58 has by way of example, at its valve-disc-side end, a radially outwardly facing shoulder 74 which forms an axial abutment surface for the piston ring 64. The piston ring 64 is designed in such a way that it fluid-tightly closes with the inner wall of the rebound stop sleeve 44. The piston ring 64 has by way of example a passage opening 76 through which hydraulic fluid can flow. The rebound stop piston 46 preferably has a disc 68 which is arranged at that end of the valve body 58 which faces upwards, in the direction of the closure assembly 34. The disc 68 preferably protrudes radially beyond the valve body 58 and in particular forms an axial abutment surface for the piston ring 64. The rebound stop piston 46 preferably comprises a fastening means 30 for fastening the rebound stop piston 46 to the piston rod 20. The valve body 58, the valve discs 62, and the disc 68 are preferably fixed to the piston rod 20 in particular by means of the fastening means 30. The fastening means 30 preferably comprises at least one, by way of example two, catch rings 50, 52. In particular, the fastening means 30 has a first catch ring 50 which forms the closure-assembly-side end of the rebound stop piston 46. The fastening means 30 in particular also has a second catch ring 52 which forms the working-piston-side end of the rebound stop piston 46. The first and the second catch ring 50, 52 are preferably of annular design and arranged circumferentially around the piston rod 20. In particular, the catch rings 50, 52 are clamped with the piston rod 20. Preferably, the piston rod 20 has a first and a second recess 54, 55, which are each at least partially or completely formed in the circumferential direction in the piston rod 20. By way of example, the first catch ring 50 is at least partially arranged in the first recess 54 and forms therewith a press-fit connection or clamping connection. By way of example, the second catch ring 52 is at least partially arranged in the second recess 55 and forms therewith a press-fit connection or clamping connection.

The valve body 58, the valve discs 62, the piston ring 64 and the disc 68 are preferably arranged axially between the first and the second catch ring 50, 52. By way of example, arranged between the valve discs 62 and the second catch ring 52 is a spacer disc 66 which spaces the valve discs 62 apart from the second catch ring 52 and thus preferably enables an opening of the valve discs 62. The spacer disc 66 preferably has a smaller diameter than the valve discs 62 and lies directly against them, in particular against the lowermost valve disc.

The piston ring 64 is preferably arranged around the valve body 58 in such a way that it is movable axially, in particular in a continuously variable manner, from a first position, in which it lies against the shoulder 74 of the valve body 58, into a second position, in which it lies against the disc 68. The valve body 58 preferably has, on its outer surface, apertures (not illustrated) which are preferably arranged aligned with cutouts in the disc 68, with the result that preferably a bypass channel is formed between the rebound stage working chamber 56 and the first working chamber 22. The apertures are preferably formed in the radially outwardly facing circumferential surface of the valve body 58. The valve body 58 has by way of example a plurality of apertures which are arranged spaced apart circumferentially by way of example uniformly with respect to one another. The apertures preferably extend in the axial direction from that end of the valve body 58 which is remote from the piston rod up to the shoulder 74 of the valve body 58. By way of example, the apertures are of half-shell-like design with a semicircular cross section. The apertures preferably have a round, part-circle or angular cross section. In particular, the apertures are all of identical design.

When the rebound stop piston 46 moves in the rebound direction Z, the piston ring 64 lies against the shoulder 74 of the valve body 58 and at least partially closes the bypass channel. In the position shown in FIG. 3, the bypass channel has a first flow cross section which corresponds by way of example to the cross section of the passage opening 76 in the piston ring 64. When the rebound stop piston 46 moves in the bump direction D, the piston ring 64 lies against the disc 68 and preferably releases the bypass channel. In this position of the piston ring 64, the bypass channel has a second flow cross section which is greater than the first flow cross section. The piston ring 64 preferably serves as a throttle element for throttling the flow cross section of the bypass channel.

The disc 68 preferably has a plurality of cutouts through which the hydraulic fluid can flow. The cutouts are preferably arranged aligned with the apertures. In particular, at least some of the cutouts are arranged aligned with the passage bores 60. The bypass channel is preferably formed by the cutouts in the disc 68, the apertures in the valve body 58 and the piston ring 64. The disc 68 is, for example, rotatable about the axial central axis of the rebound stop piston 46, with the result that the orientation of the cutouts relative to the passage bores 60 and the apertures is settable and thus the flow cross section is variable.

The piston ring 64 has, for example, a passage opening 76 which is in the form of a slot and constitutes a complete circumferential interruption of the annular piston ring 64. By way of example, the piston ring 64 has a plurality of, in particular two, three, four or more passage openings 76. Preferably, opposite passage openings 76 are of identical design. For example, the passage opening 76 is in the form of an aperture in the inner wall and/or the piston-rod-side end side of the piston ring 64.

### LIST OF REFERENCE SIGNS

10 Vibration damper
12 Outer tube
14 Damper tube/inner tube
16 Equalizing chamber
18 Working piston
20 Piston rod
22 First working chamber
24 Second working chamber
26 Apertures in the rebound stop sleeve
30 Fastening means
34 Closure assembly
36 Base piece
44 Rebound stop sleeve
46 Rebound stop piston
48 Rebound stop arrangement
50 First catch ring
52 Second catch ring
54 First recess
55 Second recess
56 Rebound stage working chamber
58 Valve body
60 Passage bores
62 Valve discs
64 Piston ring/throttle element
66 Spacer disc
68 Disc
70 Valve device
74 Shoulder
76 Passage opening
Z Rebound direction
D Bump direction

1. A vibration damper for a vehicle, comprising:
a damper tube filled with hydraulic fluid;
a working piston which is connected to a piston rod and arranged within the damper tube so as to be movable back and forth, wherein the interior of the damper tube is divided by the working piston into a piston-rod-side working chamber and a working chamber remote from the piston rod;
a closure assembly which fluid-tightly closes off the damper tube at the piston rod side;
a rebound stop arrangement having a rebound stop piston, which is mounted on the piston rod, and a rebound stop sleeve for receiving the rebound stop piston in the rebound stage;
wherein the rebound stop piston separates off a rebound stage working chamber within the rebound stop sleeve;
wherein the rebound stop piston has a bypass channel for fluidically connecting the piston-rod-side working chamber to the rebound stage working chamber;
wherein a valve device is arranged in the rebound stop piston hydraulically in parallel to the bypass channel.

2. The vibration damper according to claim 1, wherein the rebound stop piston has a throttle element for setting the flow cross section of the bypass channel, said throttle element being mounted so as to be movable in the axial direction.

3. The vibration damper according to claim 2, wherein the throttle element is designed and arranged in such a way that it, in a first position, releases a first flow cross section of the bypass channel and, in a second position, releases a second flow cross section of the bypass channel.

4. The vibration damper according to claim 3, wherein the first flow cross section is smaller than the second flow cross section.

5. The vibration damper according to claim 2, wherein the throttle element is arranged in such a way that it is moved into the first position when the rebound stop piston moves in the rebound direction and into the second position when the rebound stop piston moves in the bump direction.

6. The vibration damper according to claim 2, wherein the throttle element is of annular design.

7. The vibration damper according to claim 1, wherein the valve device has a valve body having a plurality of passage bores which are covered by at least one valve disc.

8. The vibration damper according to claim 7, wherein the valve body has a radial shoulder against which the throttle element lies in the first position.

9. The vibration damper according to claim 7, wherein the rebound stop piston has a disc which lies against the valve body, and wherein the throttle element lies against the disc in the second position.

10. The vibration damper according to claim 1, wherein the rebound stop piston lies fluid-tightly against the inner wall of the rebound stop sleeve, and wherein the rebound stop sleeve forms a guide for the rebound stop piston.

11. The vibration damper according to claim 1, wherein the rebound stop piston is fastened to, in particular clamped or pressed on, the piston rod by a fastening means.

12. The vibration damper according to claim 11, wherein the fastening means has at least one catch ring.

13. The vibration damper according to claim 11, wherein the fastening means has a first catch ring and a second catch ring, and wherein the valve device of the rebound stop piston is arranged between the first and the second catch ring.

14. The vibration damper according to claim 13, wherein the rebound stop piston has a spacer disc which lies against the valve disc and a catch ring.

15. The vibration damper according to claim 1, wherein the valve device is in the form of a check valve.
